(19) United States
(12) Patent Application Publication
(10) Pub. No.: US 2005/0073507 A1
(43) Pub. Date: Apr. 7, 2005

(54) Touch input sensing device

(76) Inventors: Paul J. Richter, Chelmsford, MA (US); Darran R. Cairns, Billerica, MA (US); Frank J. Bottari, Acton, MA (US)

Correspondence Address: 3M INNOVATIVE PROPERTIES COMPANY, PO BOX 33427, ST. PAUL, MN, 55133-3427, US

(21) Appl. No.: 10/679,903

(22) Filed: Oct. 6, 2003

(51) Int. Cl. G09G 5/00

(52) U.S. Cl. 345/174

(57) ABSTRACT

A touch sensor and a method of sensing are disclosed. The touch sensor includes a self-supporting flexible glass layer disposed on a conductive film. The touch sensor further includes electrical circuitry configured to detect a signal induced by capacitive coupling between the conductive film and a touch input applied to the flexible glass layer.

### FIELD OF THE INVENTION

This invention generally relates to sensing devices. The invention is particularly applicable to capacitive sensing devices.

### BACKGROUND

Touch screens allow a user to conveniently interface with an electronic display system by reducing or eliminating the need for a keyboard. For example, a user can carry out a complicated sequence of instructions by simply touching the screen at a location identified by a pre-programmed icon. The on-screen menu may be changed by re-programming the supporting software according to the application. As another example, a touch screen may allow a user to transfer text or drawing to an electronic display device by directly writing or drawing onto the touch screen.

Resistive and capacitive are two common touch sensing methods employed to detect the location of a touch input. Resistive technology typically incorporates two transparent conductive films as part of an electronic circuit that detects the location of a touch. Capacitive technology, on the other hand, typically uses a single transparent conductive film to detect the location of an applied touch.

A characteristic of a touch screen is the touch implement. Capacitive touch sensors generally require a conductive stylus such as a user's finger. Resistive type touch sensors, on the other hand, can generally detect a touch applied by both a conductive touch implement, such as a user's finger, and a non-conductive stylus, such as a user's fingernail.

Another characteristic of a touch screen is durability. A touch implement can scratch or otherwise damage a touch sensor, thereby reducing the touch accuracy of the sensor or even rendering the device nonfunctional.

In a capacitive touch sensor, the transparent conductive film is often deposited on an insulating substrate and can be covered with a thin dielectric coating to protect the conductive film from damage. The thin dielectric coating, however, is very thin, typically no more than one micron in thickness and therefore, may not sufficiently protect the conductive film from damage that can be caused by, for example, a sharp touch implement. A thicker dielectric coating can increase manufacturing cost and can generally reduce the coating quality by introducing stress-related cracks and cosmetic defects in the coating. Furthermore, abrasion of the thin dielectric coating under normal use can result in thickness variation in the thin dielectric coating. Such variation can affect touch accuracy and result in undesirable visible cosmetic defects. Therefore, there remains a need for capacitive touch screens with improved durability and overall performance.

### SUMMARY OF THE INVENTION

Generally, the present invention relates to sensing devices. The present invention also relates to methods of sensing.

In one aspect of the invention, a capacitive touch sensor includes a conductive film that covers a touch sensitive area. The touch sensor further includes a self-supporting flexible glass layer disposed on the conductive film. The touch sensor further includes electrical circuitry configured to detect a signal induced by capacitive coupling between the conductive film and a touch input applied to the flexible glass layer. The signal is used to determine the touch location.

In another aspect of the invention, a capacitive touch sensor includes a conductive film disposed between and optically coupled to a self-supporting flexible glass film and a substrate. The capacitive sensor further includes electronics configured to determine location of a touch input, applied to the flexible glass layer, by detecting a signal induced by capacitive coupling between the conductive film and the touch input.

In another aspect of the invention, a capacitive touch sensor includes a conductive film that covers a touch sensitive area. The touch sensor is capable of detecting two or more distinct touch locations within the touch sensitive area. The touch sensor further includes a glass layer disposed on the conductive film. The glass layer has a thickness in the range of 0.1 to 2.0 mm. The touch sensor further includes a controller configured to detect a signal induced by capacitive coupling between the conductive film and a touch input applied to the glass layer. The signal is detected at a plurality of positions on the conductive film and is used to determine the location of the applied touch input.

In another aspect of the invention, a method of determining location of a touch input to a touch sensor includes the step of capacitively coupling the touch input to a conductive film that covers a touch sensitive area. The capacitive coupling occurs through a self-supporting flexible glass layer disposed over the conductive film. The method also includes the step of detecting a signal induced by the capacitive coupling. The method further includes the step of using the detected signal to determine the touch location.

In another aspect of the invention, a method of determining a touch location includes the step of defining a touch sensitive area that includes a self-supporting glass layer disposed on a transparent conductive film. The method further includes the step of detecting a signal that is generated in response to a capacitive coupling between the conductive film and a touch input applied to the glass layer. The method also includes the step of using the detected signal to determine the touch location.

In another aspect of the invention, a touch display includes a display substrate. The touch display further includes a flexible glass layer disposed on the display substrate. The flexible glass covers a touch sensitive area. The touch display further includes an active display component and an electrically continuous optically transparent conductive film disposed between the display substrate and the flexible glass layer. The display component and the conductive film cover the touch sensitive area. A location of a touch input applied to the flexible glass layer is determined by detecting a signal induced by capacitive coupling between the conductive film and the touch input.

### BRIEF DESCRIPTION OF DRAWINGS

The invention may be more completely understood and appreciated in consideration of the following detailed description of various embodiments of the invention in connection with the accompanying drawings, in which:

FIG. 1 illustrates a schematic side view of a touch sensor in accordance with an embodiment of the invention;

FIG. 2 illustrates a schematic three dimensional view of a touch sensor in accordance with another embodiment of the invention;

FIG. 3 illustrates a schematic side view of a touch sensor in accordance with yet another embodiment of the invention;

FIG. 4 illustrates a schematic side view of a display system in accordance with another embodiment of the invention;

FIG. 5 illustrates a schematic three dimensional view of a touch sensor in accordance with an embodiment of the invention; and

FIG. 6 illustrates a schematic side view of a touch display in accordance with another embodiment of the invention.

### DETAILED DESCRIPTION

The present invention generally relates to sensing devices. The invention is particularly applicable to capacitive sensing devices, and even more particularly to capacitive touch sensors that have high durability.

Capacitive is a technology commonly used to detect the location of a touch input. In this case, a signal is generated when a conductive touch implement, such as a user's finger, is brought sufficiently close to a conductive film to allow capacitive coupling between the two conductors. The two conductors can be electrically connected to each other, for example, through the earth ground.

A capacitive touch sensor may be digital or analog. The touch sensitive area of a digital capacitive sensor can typically include a plurality of discrete electrically isolated conductive films. For example, the touch sensitive area may include a set of discrete touch pads. As another example, the touch sensitive area can include a plurality of electrically isolated parallel rows or columns of conductive films. In a digital capacitive touch sensor, the coordinates of a touch input can be determined by using discrete, or equivalently distinct, signals induced by the touch. In an analog capacitive touch sensor the touch sensitive area can be covered by an electrically continuous conductive film. In such a case, the signal induced by a touch input can include a signal that can assume a non-discrete, or equivalently, any one of a continuous set of possible values. In an analog capacitive touch sensor, the coordinates of a touch input can be determined by detecting and using the continuous signal induced by the touch. The accuracy of determining the touch location can be limited by the electronics used to process the induced signal.

A scratch in a conductive film in a capacitive touch sensor, particularly in an analog capacitive touch sensor, can lead to substantial inaccuracy in determining the location of a touch input. To guard against the occurrence of a scratch, the conductive film can typically be coated with a thin dielectric film, although some capacitive touch sensors may not have a dielectric coating. The dielectric film, however, may be too thin to protect the conductive film against abrasion due to normal use or, for example, a sharp touch implement. As such, there is a need for a highly durable capacitive touch sensor capable of withstanding abrasions with no or reduced degradation in the accuracy of determining a touch location.

According to one aspect of the present invention, a capacitive touch sensor includes a conductive film and a self-supporting flexible glass layer disposed on the conductive film. The glass layer is sufficiently thick to protect the conductive film against scratches and other extraneous factors. The glass layer is also sufficiently flexible to facilitate manufacturing of the sensor.

A touch sensor according to the present invention can advantageously be utilized in a number of applications. One such application is a touch display that is capable of including a signature capture area. Such a touch display may be used, for example, in a point of sale terminal, a security system or a check-out system where, for example, the signature of a customer can be captured and processed electronically during a credit transaction. The customer may sign his or her name with a recording instrument such as a pen, a stylus, or some other instrument capable of working with the touch display. The recording instrument can be active, meaning that it can be coupled to the touch display. For example, the recording instrument can be a stylus connected to the touch display via an electrically conductive wire. As another example, the recording instrument can be RF (Radio Frequency) coupled to the touch display. In general, the touch display can utilize any technology that would allow the recording instrument to communicate with the touch display. The capacitive touch sensor of the present invention can be substantially more durable than a conventional capacitive touch system in the application discussed above. The denser and substantially thicker glass of the present invention, compared to a conventional dielectric coating typically used in current analog capacitive devices, can provide significant protection for the conductive film against extraneous factors such as scratches that can be caused by, for example, normal use.

One or more embodiments of the current invention have particular utility in applications where it may be desirable to have a conductive film with high sheet resistance. Typically, a higher sheet resistance conductive film corresponds to a thinner film. As such, the film can become more susceptible to, for example, abrasions, which can adversely affect the accuracy of detecting a touch location. The current invention can provide significant protection for a high sheet resistance conductive film against scratches, abrasions, and other external factors. It will be appreciated that the sheet resistance of a conductive film may be changed, for example, increased, without changing the film thickness. For example, the sheet resistance may be increased by modifying the film composition. Even where a higher sheet resistance conductive film is not thinner than a lower sheet resistance conductive film, or a higher sheet resistance film is not more susceptive to external factors than a lower sheet resistance film, various embodiments of the present invention may be used to protect the conductive film against external factors.

As another application, the current invention can be used in a capacitive touch sensor where the conductive film includes a conductive polymer. Conductive polymers can typically be susceptible to moisture and other environmental factors, especially at elevated temperatures. A thin dielectric coating may not be able to sufficiently protect a conductive polymer film against environmental factors such as moisture. This lack of protection can, for example, be due to the porosity of the dielectric coating or coating defects that can result in pinholes in the dielectric coating. According to one aspect of the present invention, a self-supporting flexible glass layer can protect a conductive film that includes a conductive polymer against adverse environmental factors such as moisture.

As yet another application, a touch sensor according to one aspect of the present invention can be employed to protect the active layers in an Organic Light Emitting Display (OLED). Typically, the active layers in an OLED device can substantially degrade when exposed to environmental factors such as moisture and/or oxygen, especially at elevated temperatures. Typically, a glass layer can be used to protect the active layers. A capacitive touch sensor according to one aspect of the present invention can be utilized to protect the active layers in an OLED device against environmental and other factors. For example, according to one aspect of the invention, a self-supporting flexible glass layer can replace the glass layer that could otherwise be used to protect the active layers.

In general, the current invention can be utilized in any application where it may be desirable to protect one or more layers in a touch sensor or a touch display system from abrasions, scratches, environmental factors such as moisture and oxygen, or any other extraneous factor against which a thin dielectric coating may not be able to sufficiently protect.

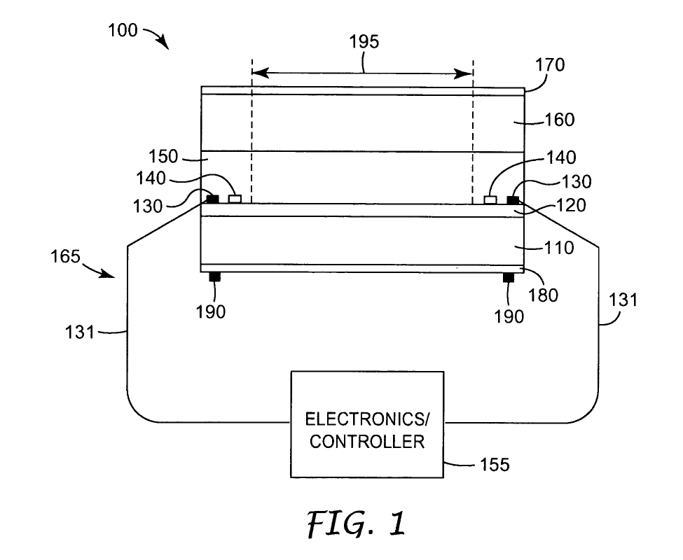

FIG. 1 illustrates a capacitive touch sensor 100 in accordance with one particular embodiment of the present invention. Capacitive touch sensor 100 includes a substrate 110, an electrically continuous optically transparent conductive film 120, an optional optically transparent bonding layer 150, and an optically transparent glass layer 160.

Glass layer 160 can be any type of optically transparent glass. Exemplary glass materials include soda lime glass, borosilicate glass, borate glass, silicate glass, any oxide glass and silica glass. Glass layer 160 is preferably flexible, meaning that the glass layer is sufficiently thin that it can be bent without structurally damaging the layer. Glass layer 160 is preferably thin enough to be capable of bending to a radius of curvature ranging from 1500 to 600 mm, and more preferably to a range of 1400 to 500 mm, and even more preferably to a range of 1200 to 400 mm. In one aspect of the invention, glass layer 160 has a thickness preferably in the range of 0.1 to 2.0 mm, and more preferably in the range of 0.3 to 1.5 mm, and even more preferably in the range of 0.5 to 1.0 mm. Furthermore, glass layer 160 is preferably self-supporting. According to the present invention, a self-supporting layer is a film that can sustain and support its own weight without breaking, tearing, or otherwise being damaged in a manner that would make it unsuitable for its intended use.

The electrically continuous optically transparent conductive film 120 can be a metal, semiconductor, doped semiconductor, semi-metal, metal oxide, an organic conductor, a conductive polymer, and the like. Exemplary metal conductors include gold, copper, silver, and the like. Exemplary inorganic materials include transparent conductive oxides, for example indium tin oxide (ITO), fluorine doped tin oxide, tin antimony oxide (TAO), and the like. Exemplary organic materials include conductive polymers such as polypyrrole, polyaniline, polyacetylene, and polythiophene, such as those disclosed in European Patent Publication EP-1-172-831-A2. The sheet resistance of the conductive film 120 can be in the range of 50 to 100,000 Ohms/square. The sheet resistance of the conductive film 120 is preferably in the range of 100 to 50,000 Ohms/square, and more preferably in the range of 200 to 10,000 Ohms/Square, and even more preferably in the range of 500 to 4,000 Ohms/Square.

The exemplary touch sensor 100 defines a touch sensitive area 195. According to the present invention, electrically continuous optically transparent conductive film 120 preferably covers the touch sensitive area 195. In some applications, film 120 can cover a portion of the touch sensitive area. In some other applications, film 120 can cover more than the touch sensitive area as illustrated in FIG. 1. In yet some other applications, film 120 can cover a portion of the touch sensitive area and extend into areas not sensitive to touch.

A particular advantage of the present invention is that glass layer 160 is sufficiently thin to allow detection of a signal induced by capacitive coupling between a conductive touch implement and the conductive film 120. At the same time, according to the present invention, glass layer 160 is thick enough to make the layer self-supporting and processable. Furthermore, glass layer 160 is thick enough so that abrasion due to, for example, normal use results in fewer or no cosmetic defects such as discoloration that would normally occur when the thickness of layer 160 is on the order of a few wavelengths. In addition, glass layer 160 is thick enough to protect the conductive film 120 from damage, such as a deep scratch in the glass layer, which may result from a user's fingernail, a coin, a pen, or any sharp touch input applied to the touch sensitive area 195.

Another particular advantage of the present invention is that layer 160 includes glass. A layer similar to layer 160 in thickness, but made of organic materials such as polycarbonate, acrylic, polyethylene terephthalate (PET), polyvinyl chloride (PVC), polysulfone, and the like, would be much softer than glass and therefor, more susceptible to scratches. For example, according to a pencil hardness test (see ASTM D 3363, Test Method for Film Hardness by Pencil Test) PET has a pencil hardness of about 1H, whereas glass has a much higher hardness of about 6H. According to the present invention, layer 160 includes glass to protect conductive layer 120 from damage, and is preferably flexible to make it more processable. A flexible layer 160 often means a thin layer 160. Therefore, according to one aspect of the present invention, flexible layer 160 is sufficiently thin so that signals induced by capacitive coupling between a conductive touch implement and a conductive film 120 are sufficiently large to make the induced signal detectable and differentiable from background noise so that the touch location can be adequately determined.

Another advantage of the present invention is low temperature processing. Conventional capacitive touch sensors typically use a thin sol-gel based silica coating to protect the conductive film. The sol-gel coating can often require a high temperature curing or sintering step, sometimes referred to as firing, that can exceed 500° C. In contrast, according to one aspect of the present invention, the optional bonding layer 150 can be used to bond the thin glass layer 160 to the conductive film 120 at low temperatures, for example, at approximately room temperature. Low temperature processing is particularly advantageous where the conductive film 120 cannot withstand high temperature processing. For example, conductive organic layers, such as an intrinsically conductive polymer, typically cannot withstand high temperature processing. According to one aspect of the present invention, the optional bonding layer 150 can be dried and/or cured at low temperatures. For example, the bonding layer can be cured by exposure to radiation, such as Ultra Violet (UV) radiation. In the case of exposure to UV radiation, it may be advantageous for the bonding layer to include UV absorbers to protect the conductive film 120 from UV radiation. The bonding layer can also be cured at other wavelengths or wavelength ranges, such as blue or green. In one aspect of the invention, the bonding layer can be cured by exposure to gamma radiation. In another aspect of the present invention, the bonding layer can be thermally cured. The curing temperatures can be well below temperatures that could adversely affect other layers in the touch sensor 100. In general, the bonding layer may be solidified and/or cured using any drying and/or curing technique. It will be appreciated that although it may be advantageous for the bonding layer to be solidified and/or cured at low temperatures, the bonding layer can be processed at high temperatures. For example, the bonding layer 150 can include a sol-gel and may be cured by a firing step.

An advantage of using the optional bonding layer 150 can be improved touch sensor impact and shatter resistance. Bonding layer 150 can provide adhesive support for glass layer 160 across the touch sensor area, for example, across the touch sensitive area 195. In the event glass layer 160 breaks, the broken fragments can remain adhered to other components in touch sensor 100, such as substrate 110. Increased shatter resistance can permit use of a thinner glass layer 160.

The present invention is particularly advantageous in a capacitive touch sensor or a capacitive touch display system that includes one or more layers that are sensitive to environmental factors such as oxygen and moisture, especially at elevated temperatures. Generally, permeability coefficient of organic layers can be quite high. For example, permeability coefficient of poly-methyl-methacrylate is 0.116×10⁻¹³ (cm³×cm)/(cm²×s×Pa) for oxygen at 34° C. and 480×10⁻¹³ (cm³×cm)/(cm²×s×Pa) for water at 23° C. (see, for example, Polymer Handbook, 4^{th} Edition, J. Brandrup, E. I. Immergut, and E. A. Grulke, Publisher: John Wiley, & Sons, Inc., page VI/548). In sharp contrast, the permeability coefficient of a glass layer 160 is effectively zero for any permeant such as oxygen and water. As such, layer 160 can be utilized to effectively protect environmentally sensitive layers from environmental factors such as oxygen and moisture. One such environmentally sensitive layer is a conductive polymer film. Other environmentally sensitive layers include, for example, active layers used in an OLED device.

Substrate 110 can be electrically insulating. Substrate 110 may be rigid or flexible. Substrate 110 may be optically opaque or transmissive. The substrate may be polymeric or any type of glass. For example, the substrate may be float glass, or it may be made of organic materials such as polycarbonate, acrylic, polyethylene terephthalate (PET), polyvinyl chloride (PVC), polysulfone, and the like. Substrate 110 may include a metal, in which case, the substrate can also be used as conductive film 120.

Touch sensor 100 further includes an optional bonding layer 150 which may be optically transmissive or opaque. Bonding layer 150 is disposed between and is preferably optically coupled to the conductive film 120 and glass layer 160. Optionally, bonding layer 150 may be in contact with either or both layers 120 and 160. Bonding layer 150 can be optically diffusive by, for example, dispersing particles in a host material where the indices of refraction of the particles and the host material are different. Bonding layer 150 can be an adhesive. Exemplary materials incorporated in bonding layer 150 include UV curable adhesives, pressure sensitive adhesives, epoxies, urethanes, thiolenes, cyano acrylates, heat activated adhesives and thermoset adhesives.

Touch sensor 100 can be flexible or rigid. A flexible touch sensor 100 can, for example, be used to conform to a curved display, such as a curved cathode ray tube (CRT) display. In one embodiment of the invention, flexible components are used to make a rigid touch sensor 100.

Touch sensor 100 further includes electrical circuitry 165 configured to detect a signal induced by capacitive coupling between the conductive film 120 and a touch input applied to the glass layer 160. The detected signal can be used to determine the touch location. According to one aspect of the invention, electrical circuitry 165 includes electrodes 130 disposed on conductive layer 120 and electrically conductive leads 131 that electrically connect conductive layer 120 and electrodes 130 to electronics and controller 155. Electrical circuitry 165 can electrically transmit the detected signal to electronics and controller 155. Electronics and controller 155 can receive and process the detected signal to determine the touch location.

Electrodes 130 can be optically transmissive or opaque. Electrodes 130 can be formed using a conductive ink such as, for example, a thermally cured silver epoxy, or an electrically conducting composition containing an electrical conductor and glass frit where the conductor can be, for example, silver, gold, palladium, carbon or an alloy composition. Electrodes 130 can be deposited onto film 120 by, for example, screen-printing, ink-jet printing, pad-printing, direct write or decal transfer.

Touch sensor 100 can further include optional linearization pattern 140 to linearize the electric field. Typically, the linearizing electrode pattern 140 can include several rows of discrete conductive segments positioned along the perimeter of the touch sensitive area, such as disclosed in U.S. Pat. Nos. 4,198,539; 4,293,734; and 4,371,746. The conductive segments can typically be electrically connected to each other via the conductive film 120. U.S. Pat. No. 4,822,957 discloses rows of discrete electrodes having varying lengths and spacings to linearize the electric field in a touch sensitive area.

In the exemplary embodiment shown in FIG. 1, the glass layer 160 and the optional bonding layer 150 cover a portion of the electrical circuitry 165. In particular, they cover electrodes 130. In some applications, electrodes 130, or more generally, electrical circuitry 165 may be partially covered or not covered by the glass layer 160 and/or bonding layer 150. Touch sensor 100 may further include additional electrically conductive segments (not shown in FIG. 1) to further electrically connect linearization pattern 140 to electrodes 130.

In the exemplary embodiment shown in FIG. 1, conductive film 120 is disposed onto substrate 110. According to one aspect of the invention, conductive film 120 can be disposed on the bottom surface of glass layer 160. Electrodes 130 and linearization pattern 140 can also be disposed on the bottom surface of the glass layer. Furthermore, electrodes 130 and linearization pattern 140 can be disposed between conductive film 120 and substrate 110. In general, taking conductive film 120, electrodes 130, and linearization pattern 140 as a group, a portion of the group can be disposed on substrate 110 and the remaining portion of the group can be disposed on the bottom surface of glass layer 160. For example, in the exemplary embodiment shown in FIG. 1, the entire group is disposed on substrate 120. As another example, the entire group can be disposed on the bottom side of glass layer 160.

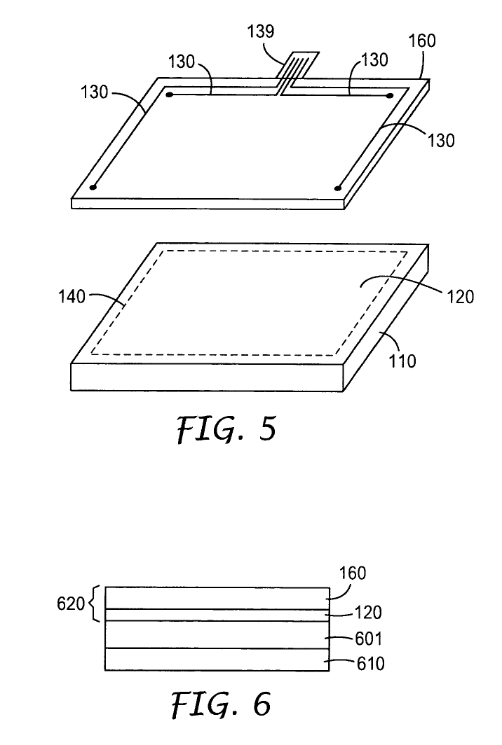

FIG. 5 illustrates a schematic three dimensional view of a touch sensor according to another aspect of the present invention. For ease of illustration and without loss of generality, some of the layers and components shown in FIG. 1 are not reproduced in FIG. 5. In FIG. 5, conductive film 120 and linearization pattern 140 are disposed on substrate 110. Furthermore, electrodes 130 are disposed on the bottom surface of glass layer 160. FIG. 5 further shows an optional electrical tail 139 disposed, for example, onto the bottom surface of glass layer 160. Tail 139 can, as another example, be disposed onto substrate 110. Conductive leads 131 (not shown in FIG. 5) can, for example, be electrically connected to electrodes 130 via tail 139.

Referring back to FIG. 1, touch sensor 100 can further include an optional conductive shield 180 and a ground electrode 190 to isolate the sensing surface from noise and stray capacitance associated with, for example, the display and/or the display bezel.

The top and/or bottom surface of glass layer 160 can be smooth or structured. The structure can, for example, be random or include a regular pattern. For example, a surface can have a random matte finish. The surface can have one or two-dimensional microstructures. A structured surface can reduce glare. A structured top surface can also reduce the possibility of slippage when, for example, a touch implement is applied to the glass layer. A structured surface may also reduce the visibility of fingerprints on the touch surface.

Touch sensor 100 can further include other optional layers. For example, touch sensor 100 can include an anti-reflection (AR) coating 170 disposed onto glass layer 160 to reduce specular reflection. The top surface of AR coating 170 may be matte to further reduce specular reflection and slippage. Layer 170 can include a multilayer film. The multilayer film can, for example, include alternate layers having high and low indices of refraction. Other optional layers that can be incorporated in touch sensor 100 include polarizers, neutral density filters, color filters, compensation films, retarders, optical diffusers and privacy films.

Touch sensor 100 can further include optional layers to protect the conductive film 120 from other layers in the sensor. For example, an optional hard coat or barrier layer can be disposed between the conductive film 120 and the optional bonding layer 150 to protect the conductive film against potential damage from the bonding layer. One such potential damage may, for example, be from the acidic nature of an adhesive-type bonding layer that could potentially attack and degrade the performance of the conductive film 120.

According to one aspect of the present invention, controller 155 is configured to detect a signal induced by capacitive coupling between conductive film 120 and a conductive touch input applied to glass layer 160. The signal detected by the controller can be used to determine the touch location. For example, the characteristics of the detected signal, such as magnitude and phase, can be such that the controller can distinguish the detected signal from any background noise or undesired signal, thereby resulting in a sufficiently large signal to noise ratio to determine the touch location.

In general, as the thickness of glass layer 160 increases, the signal to noise ratio can decrease. In one aspect of the invention, an improved controller may be employed to increase the signal to noise ratio in some applications. For example, the controller available from 3M Touch Systems, Inc. under the trade designation EX II may be used to increase the signal to noise ratio. Advantages of the EX II controller include higher speed and resolution. The controller can have a 16 bit resolution compared to 10-12 bit conventional controllers. A higher bit resolution can typically improve the accuracy of determining a touch location. Furthermore, the EX II controller can be capable of a sampling rate of 1.3 ms compared to a sampling rate of about 2 ms for conventional controllers. Another advantage of the EX II controller is the capability to drive the conductive shield 180 at voltages other than the conventional ground potential. For example, the EX II controller can drive the conductive shield at a voltage level used to drive the touch sensitive area, typically 3.3, 5 or 12 volts. As a result, stray capacitance can be reduced or eliminated leading to an increase in signal to noise ratio. Another advantage of the EX II controller is the capability to filter a detected signal through a narrower band pass filter than typically used in conventional controllers. A narrower band pass filter can filter out more of the noise resulting in a higher signal to noise ratio.

In general, any controller that is capable of generating a sufficiently large signal to noise ratio may be used with the present invention.

Referring back to FIG. 1, at least a portion of conductive leads 131 may be disposed onto a layer or a film in the touch sensor. For example, at least a portion of conductive leads 131 may be disposed onto substrate 110, conductive film 120, or glass layer 160. As another example, portions of conductive leads 130 may be disposed on various layers or films in the touch sensor. For example, a portion of the conductive leads may be disposed on conductive film 120 while a different portion may be disposed on glass layer 160. As yet another example, conductive leads 131 may be disposed onto an auxiliary layer, not shown in FIG. 1, that is disposed, for example, between the glass layer 160 and substrate 110. It will be appreciated that at least a portion of electrodes 130 may also be disposed onto the auxiliary layer.

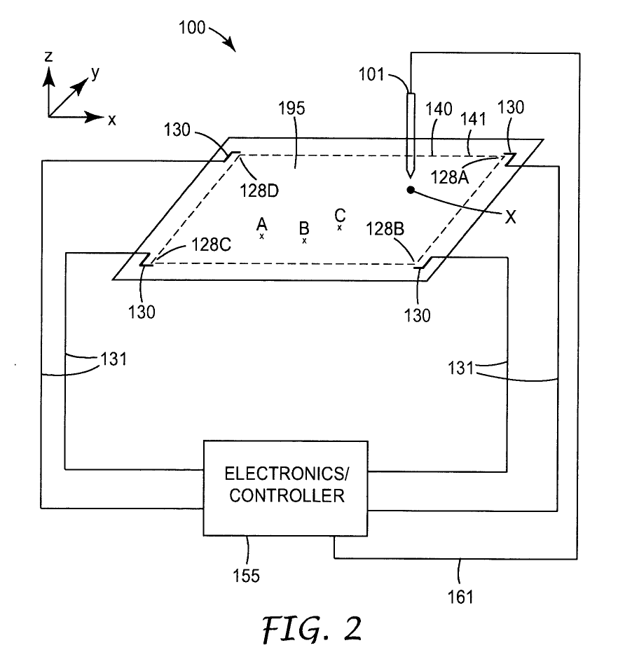

FIG. 2 shows a schematic three dimensional view of a touch sensor 100 according to one aspect of the invention. For ease of illustration and without loss of generality some of the layers and components shown in FIG. 1 are not reproduced in FIG. 2. According to one aspect of the present invention, the touch sensor 100 can be capable of detecting two or more distinct touch locations within the touch sensitive area 195. For example, touch sensor 100 can be capable of detecting distinct touch locations A, B, C, and X in the touch sensitive area 195. For ease of illustration and without loss of generality, FIG. 2 shows a linearizing electrode pattern 140 having a single row of electrically conductive segments 141 along the perimeter of the touch sensitive area 195, although the linearizing electrode pattern 140 can typically include several rows of such conductive segments. According to the exemplary embodiment of FIG. 2, electrodes 130 are positioned near the four corners of the touch sensitive area 195 and make direct electrical contact to the linearization pattern 140. In general, electrodes 130 may be positioned at multiple locations along the perimeter of the touch sensitive area.

A conductive touch implement 101, applied to the touch sensor at location X, generates a signal induced by capacitive coupling between touch implement 101 and conductive film 120. According to one aspect of the present invention, the induced signal can be detected at a plurality of positions on the conductive film to determine the location X. For example, the induced signal can be detected at four locations 128A, 128B, 128C, and 128D as shown in FIG. 2. The detected signals can be electrically transmitted to electronics and controller 155 via electrodes 130 and electrically conductive leads 131. The multiple detected signals can be used to detect the touch location X. For example, magnitudes of signals detected at locations 128A, 128B and 128C, relative to the magnitude of the signal detected at location 128D, can be used to determine the touch location X.

According to one aspect of the invention, conductive touch applicator 101 can be coupled to touch sensor 100, for example, via controller 155. The coupling means can include an electrical connection to, for example, controller 155 via, for example, electrically conductive means 161 as shown in FIG. 1. A direct electrical connection can help reduce background noise, thereby increasing the signal-to-noise ratio. An advantage of electrically connecting the touch applicator to the controller is that the thickness of glass layer 160 can be increased since the controller can be capable of detecting smaller touch induced signals. The electrically conductive means 161 can, for example, include electrically conductive wires.

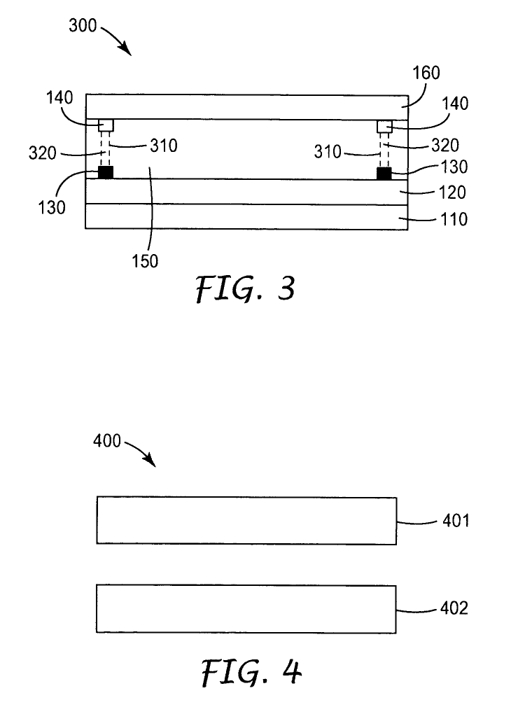

FIG. 3 illustrates a schematic side-view of a touch sensor 300 in accordance with one particular aspect of the invention. For ease of illustration and without loss of generality some of the layers and components shown in FIG. 1 and FIG. 2 are not reproduced in FIG. 3. Touch sensor 300 includes conductive electrodes 130 disposed onto the conductive film 120 and linearization pattern 140 disposed onto the bottom surface of glass layer 160. As another example, conductive electrodes 130 can be disposed onto the bottom surface of glass layer 160 and linearization pattern 140 can be disposed onto conductive film 120. Bonding layer 150 can electrically isolate linearization pattern 140 from electrodes 130 except at pre-determined locations where linearization pattern 140 and electrodes 130 are electrically connected through vias 310 formed in bonding layer 150. Vias 310 can be filled with a conductive material 320 to electrically connect linearization pattern 140 to electrodes 130. Such a stacked arrangement of linearization pattern 140 and electrodes 130 can reduce the touch panel border. This aspect of the present invention can be particularly useful in applications where it may be desirable to integrate a touch sensor with a small border display device.

Vias 310 can be formed in bonding layer 150 by punching, die cutting, laser ablation, knife cutting and chemical etching. Conductive material 320 can, for example, be a conductive paste, such as a silver conductive paste, a gold conductive paste, a palladium conductive paste or a carbon conductive paste.

FIG. 4 illustrates a schematic cross-section of a display system 400 in accordance with one aspect of the present invention. Display system 400 includes a touch sensor 401 and a display 402. Display 402 can be viewable through touch sensor 401. Touch sensor 401 can be a touch sensor according to any embodiment of the present invention. Display 402 can include permanent or replaceable graphics (for example, pictures, maps, icons, and the like) as well as electronic displays such as liquid crystal displays (LCD), cathode ray tubes (CRT), plasma displays, electroluminescent displays, OLEDs, electrophoretic displays, and the like. It will be appreciated that although in FIG. 4 display 402 and touch sensor 401 are shown as two separate components, the two can be integrated into a single unit. For example, touch sensor 401 can be laminated to display 402. Alternatively, touch sensor 401 can be an integral part of display 402.

FIG. 6 illustrates a schematic cross-section of an exemplary touch display system where a touch sensor is integrated with a display device according to one particular aspect of the present invention. FIG. 6 shows a display substrate 610, an active display component 601, and a capacitive touch sensor 620. Touch sensor 620 can be a touch sensor according to any aspect of the present invention. Touch sensor 620 includes a conductive film 120 and a glass layer 160 where film 120 and layer 160 are previously described in reference to FIG. 1. Substrate 610 can also serve as a substrate for touch sensor 620. Active component 601 can, for example, include all the components that may be used in a display system. For example, component 601 can include the active layers typically used in an OLED device including active organic layers, electrodes, insulting layers, polarizers and the like. It will be appreciated that glass layer 160 can effectively seal component 601 and, if desirable, conductive film 120. Accordingly, glass layer 160 can protect component 601 against extraneous factors such as abrasion and environmental factors such as oxygen and moisture. As another example, component 601 can include the active layers and parts typically used in an LCD display including the liquid crystal cell, polarizers, retarders, backlight, color filters, and the like. Display component 601 may be viewable through touch sensor 620. A touch input applied to the flexible glass layer 160 in a touch sensitive area capacitively couples with the conductive film 120, thereby inducing a signal. The touch location may be determined by detecting the induced signal.

Advantages and embodiments of the present invention are further illustrated by the following examples. The particular materials, amounts and dimensions recited in these examples, as well as other conditions and details, should not be construed to unduly limit the present invention.

### EXAMPLE 1

A touch sensor according to one embodiment of the present invention was assembled as follows.

A 3 mm thick square soda lime glass substrate was dip coated in a solution containing an organic conductive material available from Bayer Company under the trade designation Baytron P. The solution further included ethylene glycol and an epoxysilane coupling agent. The solution was diluted with isopropyl alcohol. The glass substrate was coated on both sides from the dipping process. The coated glass substrate was dried and cured at 85° C. for 6 minutes, resulting in conductive polymer films being formed on both sides of the glass substrate.

Next, a linearization pattern was screen printed along the perimeter of one side of the panel using a carbon-loaded conductive ink. The printed substrate was cured at 130° C. for 6 minutes.

Next, conductive leads were connected to the four corners of the linearization pattern using a conductive epoxy. The assembly was cured at 130° C. for 6 minutes.

Next, both sides of the assembly were spray coated with a solution containing a silicone modified polyacrylate and an aromatic isocyanate resin. The sprayed assembly was cured at 130° C. for 1 hour, resulting in sprayed protective coatings on both sides of the assembly.

Next, a 0.4 mm thick square soda lime glass was bonded to the side of the panel that was printed with the linearization pattern. The bonding was accomplished using the optically clear adhesive designated as adhesive 8142 available from 3M Company.

Next, the completed assembly was activated using an EX II controller connected to the conductive leads. A finger draw test resulted in a linearity better than 1%.

### EXAMPLE 2

A touch sensor according to one embodiment of the present invention was prepared similar to Example 1, except that a 0.4 mm thick rectangular soda lime glass substrate was used for the dip coating. The completed assembly was activated using a controller EX II. A finger draw test resulted in a linearity better than 1%.

### EXAMPLE 3

A touch sensor according to one embodiment of the present invention was assembled as follows.

A linearization pattern was screen printed along the perimeter of one side of a 3 mm thick rectangular soda lime glass substrate that was coated, on the same side, with a 1500 ohms per square TAO. The conductive ink used to print the linearization pattern was from DuPont Company under the trade designation 7713. The printed substrate was cured at 500° C. for 15 minutes.

Next, conductive leads were connected to the four corners of the linearization pattern similar to Example 1.

Next, a 0.4 mm thick square soda lime glass was bonded to the side of the panel that was printed with the linearization pattern. The bonding was accomplished using an optical adhesive from Norland Corporation under the trade designation NOA 68. The adhesive was cured using ultra violet radiation.

Next, the completed assembly was activated using a controller EX II connected to the conductive leads. A finger draw test resulted in a linearity better than 1%.

All patents, patent applications, and other publications cited above are incorporated by reference into this document as if reproduced in full. While specific examples of the invention are described in detail above to facilitate explanation of various aspects of the invention, it should be understood that the intention is not to limit the invention to the specifics of the examples. Rather, the intention is to cover all modifications, embodiments, and alternatives falling within the spirit and scope of the invention as defined by the appended claims.

1. A capacitive touch sensor comprising:
an electrically continuous optically transparent conductive film covering a touch sensitive area;
an optically transparent self-supporting flexible glass layer disposed on the conductive film; and
an electrical circuitry configured to detect a signal induced by capacitive coupling between the conductive film and a touch input applied to the flexible glass layer, the signal being used to determine the touch location.

2. The capacitive touch sensor of claim 1, further comprising an optically transparent bonding layer for bonding the flexible glass layer to the conductive film.

3. The capacitive touch sensor of claim 2, wherein the bonding layer is an adhesive.

4. The capacitive touch sensor of claim 2 further comprising a barrier layer disposed between the bonding layer and the conductive film.

5. The capacitive touch sensor of claim 2, wherein the bonding layer is UV curable.

6. The capacitive touch sensor of claim 5, wherein the bonding layer comprises a UV absorber.

7. The capacitive touch sensor of claim 1, further comprising a field linearization pattern disposed along the perimeter of the touch sensitive area.

8. The capacitive touch sensor of claim 7, wherein the flexible glass layer covers at least a portion of the linearization pattern.

9. The capacitive touch sensor of claim 1, wherein the conductive film is disposed on an optically transparent substrate.

10. The capacitive touch sensor of claim 1, wherein the flexible glass layer covers at least a portion of the electrical circuitry.

11. The capacitive touch sensor of claim 1, further comprising electronics adapted to receive the detected signal to determine the touch location.

12. The capacitive touch sensor of claim 1, wherein the sheet resistance of the conductive film is in the range of 100 to 50,000 Ohms/Square.

13. The capacitive touch sensor of claim 1, wherein the sheet resistance of the conductive film is in the range of 200 to 10,000 Ohms/Square.

14. The capacitive touch sensor of claim 1, wherein the sheet resistance of the conductive film is in the range of 500 to 4,000 Ohms/Square.

15. The capacitive touch sensor of claim 1, wherein the thickness of the flexible glass layer is in the range of 0.1 to 1.5 mm.

16. The capacitive touch sensor of claim 1, wherein the thickness of the flexible glass layer is in the range of 0.3 to 1.5 mm.

17. The capacitive touch sensor of claim 1, wherein the thickness of the flexible glass layer is in the range of 0.5 to 1.0 mm.

18. The capacitive touch sensor of claim 1, wherein the flexible glass layer comprises a soda lime glass.

19. The capacitive touch sensor of claim 1, wherein the flexible glass layer comprises a borosilicate glass.

20. The capacitive touch sensor of claim 1, wherein the transparent conductive film comprises a metal.

21. The capacitive touch sensor of claim 1, wherein the transparent conductive film comprises a metal oxide.

22. The capacitive touch sensor of claim 21, wherein the metal oxide comprises Indium Tin Oxide (ITO).

23. The capacitive touch sensor of claim 21, wherein the metal oxide comprises Tin Antimony Oxide (TAO).

24. The capacitive touch sensor of claim 21, wherein the metal oxide comprises fluorine doped tin oxide.

25. The capacitive touch sensor of claim 1, wherein the transparent conductive film comprises an organic conductor.

26. The capacitive touch sensor of claim 25, wherein the organic conductor comprises a conductive polymer.

27. The capacitive touch sensor of claim 1 being combined with a display viewable through the touch sensor.

28. The capacitive touch sensor of claim 1 further comprising a touch implement coupled to the touch sensor.

29. The capacitive touch sensor of claim 28, wherein the touch implement is electrically coupled to the touch sensor.

30. The capacitive touch sensor of claim 28, wherein the touch implement is coupled to the touch sensor via electrically conductive wires.

31. The capacitive touch sensor of claim 28, wherein the touch implement is a stylus.

32. A signature capture device comprising the capacitive touch sensor of claim 1.

33. A capacitive touch sensor comprising:
an electrically continuous optically transparent conductive film disposed between and optically coupled to an optically transparent self-supporting flexible glass film and an optically transparent substrate; and
electronics configured to determine location of a touch input applied to the flexible glass layer by detecting a signal induced by capacitive coupling between the conductive film and the touch input.

34. The capacitive touch sensor according to claim 33, wherein the conductive film is in contact with the flexible glass.

35. The capacitive touch sensor according to claim 33, wherein the conductive film is in contact with the substrate.

36. The capacitive touch sensor according to claim 33, wherein an optically transparent bonding layer optically couples the conductive film to the flexible glass.

37. The capacitive touch sensor according to claim 33, wherein an optically transparent bonding layer optically couples the conductive film to the substrate.

38. The capacitive touch sensor according to claims 36 or 37, wherein the bonding layer is an adhesive.

39. The capacitive touch sensor according to claim 33, further comprising a controller to receive the detected signal to determine the touch location.

40. A capacitive touch sensor comprising:
an electrically continuous optically transparent conductive film covering a touch sensitive area, the touch sensor being capable of detecting two or more distinct touch locations within the touch sensitive area;
an optically transparent glass layer disposed on the conductive film, the glass layer having a thickness in the range of 0.1 to 2.0 mm; and
a controller configured to detect a signal induced by capacitive coupling between the conductive film and a touch input applied to the glass layer, the signal being detected at a plurality of positions on the conductive film and used to determine the location of the applied touch input.

41. The capacitive touch sensor according to claim 40, wherein the optically transparent glass layer is flexible.

42. The capacitive touch sensor according to claim 40, wherein the glass layer has a thickness in the range of 0.3 to 1.5 mm.

43. A method of determining location of a touch input to a touch sensor comprising the steps of:
capacitively coupling the touch input to an electrically continuous optically transparent conductive film covering a touch sensitive area of the touch sensor, the capacitive coupling occurring through an optically transparent self-supporting flexible glass layer disposed over the conductive film;
detecting a signal induced by the capacitive coupling; and
using the detected signal to determine the touch location.

44. A method of determining a touch location comprising the steps of:
defining a touch sensitive area comprising an optically transparent self-supporting glass layer disposed on an electrically continuous optically transparent conductive film;
detecting a signal generated in response to a capacitive coupling between the conductive film and a touch input applied to the glass layer; and
using the detected signal to determine the touch location.

45. A touch display comprising:
a display substrate;
an optically transparent self-supporting flexible glass layer disposed on the display substrate and covering a touch sensitive area; and
an active display component and an electrically continuous optically transparent conductive film disposed between the display substrate and the flexible glass layer and covering the touch sensitive area, wherein a location of a touch input applied to the flexible glass layer in the touch sensitive area is determined by detecting a signal induced by capacitive coupling between the conductive film and the touch input.
